(19) United States
(12) Patent Application Publication
(10) Pub. No.: US 2007/0220207 A1
(43) Pub. Date: Sep. 20, 2007

(54) Transferring data from stacked memory

(76) Inventors: Bryan Black, Austin, TX (US); Murali Annavaram, Austin, TX (US); Paul Reed, Austin, TX (US)

Correspondence Address: CAVEN & AGHEVLI;c/o INTELLEVATE, P.O. BOX 52050, MINNEAPOLIS, MN, 55402, US

(21) Appl. No.: 11/374,936

(22) Filed: Mar. 14, 2006

(51) Int. Cl. G06F 12/00

(52) U.S. Cl. 711/118

(57) ABSTRACT

Methods and apparatus to transfer data from a stacked memory are described. In one embodiment, an interconnect may be utilized to transfer data into a buffer from one or more opened memory pages.

### BACKGROUND

The present disclosure generally relates to the field of electronics. More particularly, various embodiments of the invention relate to memory stacking and/or transferring data from stacked memory, for example, through die-to-die vias.

Memory access times may be a performance bottleneck in some computing systems. For example, when data stored in a memory is accessed through a shared bus, memory accesses may need to be synchronized with edges of a synchronization clock signal. Since the clock edges may occur at certain intervals, data accesses may need to wait for one or more clock periods before data communication can commence, even if the data is otherwise ready for transfer. Also, memory accesses through a shared bus may be further delayed, for example, because the bus may not be available until data transfers by other devices sharing the same bus are complete.

Generally, memory may include a dynamic random access memory (DRAM) chip. A DRAM chip may be organized as a two-dimensional matrix and each memory location may be accessed using a row address and column address. The total access time for a memory chip may correspond to three components: row access time, column access time, and data transfer time.

For each memory access, a row may be activated (or opened) and the row data may be moved to a page buffer. Subsequently, a column address may be used to select data from the page buffer. Furthermore, a DRAM chip may include sense amplifiers to amplify signals corresponding to data bits stored in a row. These sense amplifiers may be implemented as differential sense amplifiers and may consume more power than some of the other components of a DRAM, and their operation may increase memory latency. Accordingly, each time a row is activated, memory latency may be increased and additional power may be consumed by the corresponding sense amplifiers.

To reduce the memory access latency, an activated (or open) row may remain activated until another row is accessed. This policy may be referred to as an “open page” policy, which may work efficiently if successive operations access the same memory row. However, keeping a row open may result in additional power consumption.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a perspective view of a semiconductor device in accordance with an embodiment of the invention.

FIG. 2 illustrates a cross-sectional view of a semiconductor device according to an embodiment of the invention.

FIGS. 3, 6, and 7 illustrate block diagrams of embodiments of computing systems, which may be utilized to implement various embodiments discussed herein.

FIG. 4 illustrates a block diagram of portions of a memory system, according to an embodiment of the invention.

FIG. 5 illustrates a block diagram of an embodiment of a method to transfer data from a memory.

### DETAILED DESCRIPTION

In the following description, numerous specific details are set forth in order to provide a thorough understanding of various embodiments. However, some embodiments may be practiced without the specific details. In other instances, well-known methods, procedures, components, and circuits have not been described in detail so as not to obscure the particular embodiments.

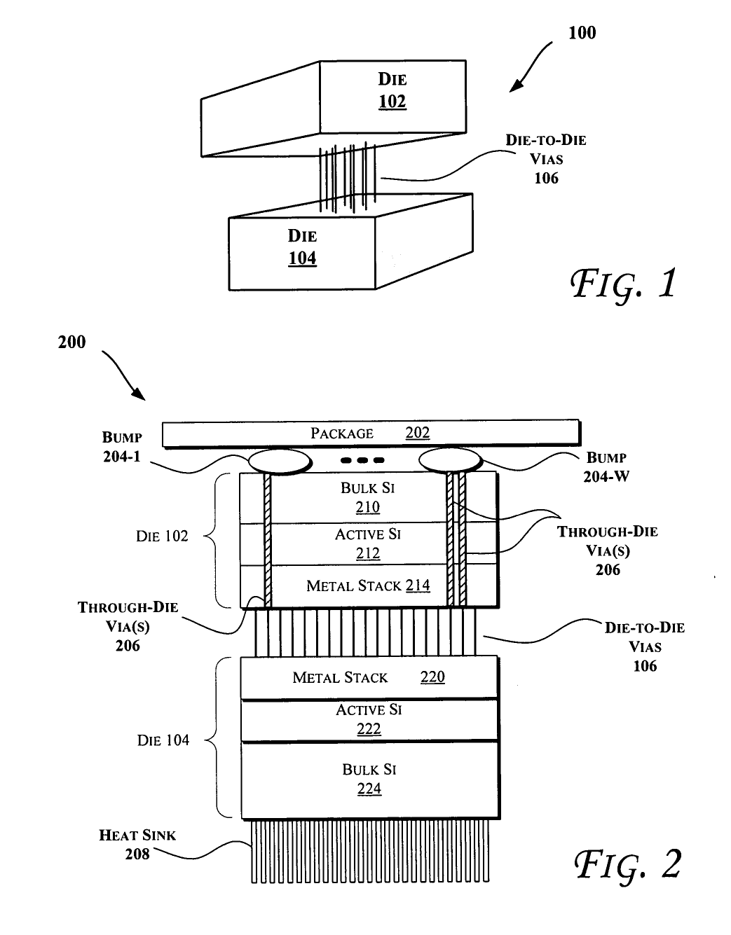

Some of the embodiments discussed herein may provide efficient mechanisms for transferring data from a stacked memory chip through a dedicated (or non-shared) interconnect, such as die-to-die vias. In an embodiment, data may be transferred (or prefetched) through vias to reduce memory latency and/or power consumption in devices or systems that include multiple dies, such as those discussed with reference to FIGS. 1-7. More particularly, FIG. 1 illustrates a perspective view of a semiconductor device 100 in accordance with an embodiment of the invention. The device 100 may include a die 102 that communicates with a die 104 through a dedicated (or non-shared) interconnect which may include one or more die-to-die vias 106. The vias 106 may be electrically conductive to allow electrical signals to pass between the dies 102 and 104.

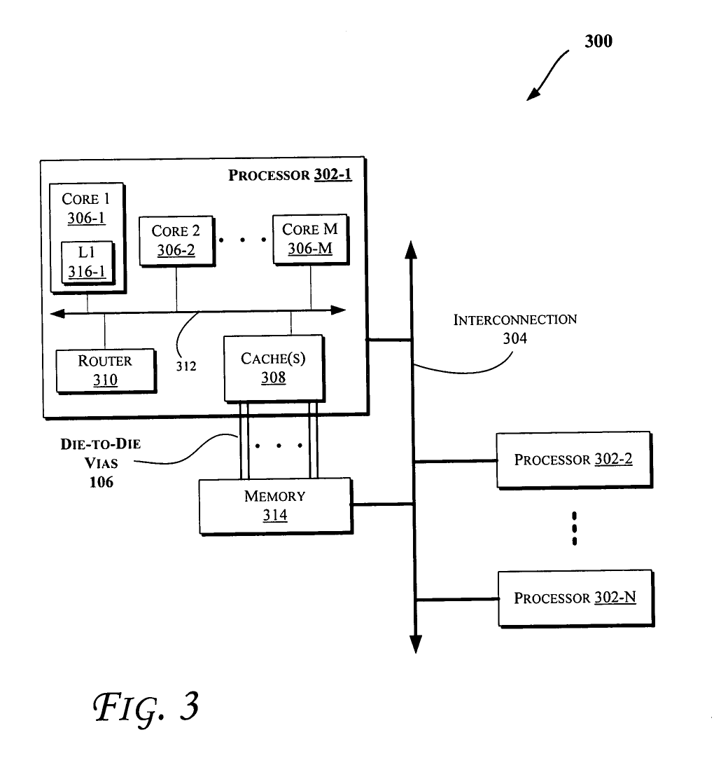

In an embodiment, vias 106 may be constructed with material such as aluminum, copper, silver, gold, combinations thereof, or other electrically conductive material. Moreover, each of the dies 102 and 104 may include circuitry corresponding to various components of a computing system, such as the components discussed with reference to FIGS. 2-7. For example, the die 102 may include a memory device and the die 104 may include one or more processor cores and/or shared or private caches. Additionally, as shown in FIG. 1, the dies 102 and 104 may overlap partially. In other embodiments, the dies 102 and 104 may overlap fully or not at all. Accordingly, dies 102 and 104 may have a three-dimensional (3D) stacking configuration. Such a configuration may provide for utilization of disparate process technologies. For example, die 102 may be manufactured using a different process than die 104, and subsequently dies 102 and 104 may be bonded after alignment of the vias 106. Also, a 3D configuration may provide for a higher density when packaging semiconductor devices. Also, more efficient system-on-chip or system-on-stack (SOS) solutions may be provided for computing devices or systems. Furthermore, even though FIG. 1 only illustrates two dies, additional dies may be used to integrate other components into the same device, such as the components discussed with reference to FIGS. 3-7.

FIG. 2 illustrates a cross-sectional view of a semiconductor device 200 in accordance with an embodiment of the invention. The device 200 may include a package 202, die 102, die 104, and die-to-die vias 106. One or more bumps 204-1 through 204-W (collectively referred to herein as “bumps 204”) may allow electrical signals including power, ground, clock, and/or input/output (I/O) signals to pass between the package 202 and the die 102. As shown in FIG. 2, the die 102 may include one or more through-die vias 206 to pass signals between the bumps 204 and the die 104. The device 200 may further include a heat sink 208 to allow for dissipation of generated heat by the die 104 and/or device 200.

As illustrated in FIG. 2, dies 102 and 104 may include various layers. For example, die 102 may include a bulk silicon (SI) layer 102, an active Si layer 212, and a metal stack 214. Die 104 may include a metal stack 220, an active Si layer 222, and a bulk Si layer 224. As shown in FIG. 2, the vias 106 may communicate with the dies 102 and 104 through the metal stacks 214 and 220, respectively. In an embodiment, die 102 may be thinner than die 104. For example, die 102 may include a memory device (such as a random access memory device) and die 104 may include one or more processor cores and/or shared or private caches, as discussed herein, e.g., with reference to FIGS. 1 and 3-7. As with the device 100 of FIG. 1, device 200 may include additional dies, e.g., to integrate other components into the same device or system. In such an embodiment, die-to-die and/or through-die vias may be used to communicate signals between the various dies (e.g., such as discussed with respect to the vias 106 and 206).

FIG. 3 illustrates a block diagram of a computing system 300, according to an embodiment of the invention. The system 300 may include one or more processors 302-1 through 302-N (generally referred to herein as “processors 302” or “processor 302”). The processors 302 may communicate via an interconnection or bus 304. Each processor may include various components some of which are only discussed with reference to processor 302-1 for clarity. Accordingly, each of the remaining processors 302-2 through 302-N may include the same or similar components discussed with reference to the processor 302-1.

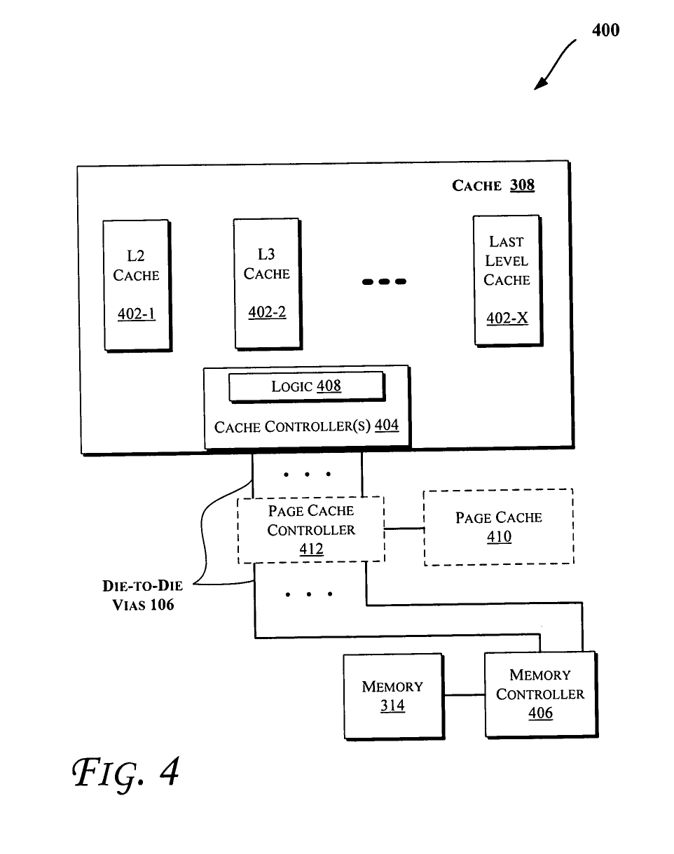

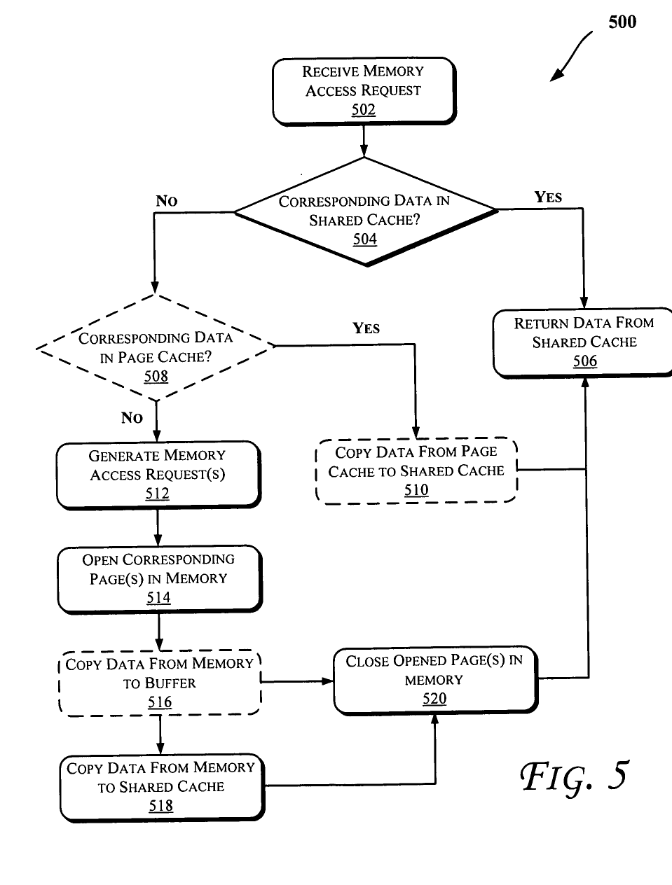

In an embodiment, the processor 302-1 may include one or more processor cores 306-1 through 306-M (referred to herein as “cores 306,” or more generally as “core 306”), a cache 308 (which may be a shared cache or a private cache), and/or a router 310. The processor cores 306 may be implemented on a single integrated circuit (IC) chip (e.g., one of the dies 102 or 104 of FIGS. 1-2). Moreover, the chip may include one or more shared and/or private caches (such as cache 308), buses or interconnections (such as a bus or interconnection 312), memory controllers (such as those discussed with reference to FIGS. 4 and 6-7), or other components.

In one embodiment, the router 310 may be used to communicate between various components of the processor 302-1 and/or system 300. Moreover, the processor 302-1 may include more than one router 310. Furthermore, the multitude of routers (310) may be in communication to enable data routing between various components inside or outside of the processor 302-1. For example, the router 310 may communicate through the vias 106 and/or 206 of FIGS. 1-2.

The cache 308 may store data (e.g., including instructions) that are utilized by one or more components of the processor 302-1, such as the cores 306. For example, the cache 308 may locally cache data stored in a memory 314 for faster access by the components of the processor 302. As shown in FIG. 3, the memory 314 may be in communication with the processors 302 via the interconnection 304. Alternatively (or additionally), the vias 106 discussed with reference to FIGS. 1-2 may be used for communication between the memory 314 and the cache 308. In one embodiment, the memory 314 may be implemented on a different integrated circuit (IC) chip (e.g., one of the dies 102 or 104 of FIGS. 1-2) than the processors 302.

In an embodiment, the cache 308 (that may be shared) may be a last level cache (LLC). Also, each of the cores 306 may include a level 1 (L1) cache (316-1) (generally referred to herein as “L1 cache 316”). Furthermore, the processor 302-1 may include a mid-level cache that is shared by several cores (306). Various components of the processor 302-1 may communicate with the cache 308 directly, through a bus (e.g., the bus 312), and/or a memory controller or hub.

FIG. 4 illustrates a block diagram of a memory system 400, according to an embodiment of the invention. The memory system 400 may be used in various computing systems, for example, such as the systems discussed with reference to FIGS. 3 and 5-7. As shown in FIG. 4, the cache 308 may include one or more levels of cache (e.g., L2 cache 402-1, L3 cache 402-3, and an LLC 402-X, generally referred to herein as “caches 402”). Each of the caches 402 may include a controller 404. Alternatively, a single cache controller 404 may be utilized to facilitate communication between various components of a computing device or system (such as those discussed with reference to FIGS. 3 and 6-7) and caches 402.

As illustrated in FIG. 4, the cache 308 may communicate via the die-to-die vias 106 (e.g., through the cache controller 404 and a memory controller 406) with the memory 314. The cache controller 404 may include a data transfer or prefetch logic 408 to perform one or more operations corresponding to transferring (or prefetching) data from the memory 314 into the cache 308, as will be further discussed with reference to FIG. 5.

In one embodiment, the system 400 may include an optional page cache 410 and an optional page cache controller 412. The page cache 410 may store data that is transferred (or prefetched) from the memory 314, and subsequently provided to the cache 308, as will be further discussed with reference to some of the operations of FIG. 5. In embodiments that include the page cache 410, the logic 408 may be provided within the page cache controller 412, or otherwise the logic 408 may communicate with the controller 412 to perform one or more operations corresponding to transferring (or prefetching) data from the memory 314 into the page cache 410, as will be further discussed with reference to some of the operations of FIG. 5. According to an embodiment, in the absence of a page cache 410 (and controller 412), the memory controller 406 and cache controller 404 may communicate through the vias 106. In an embodiment, the page cache 410 and/or controller 412 may be implemented on the same die as the cache 308. Alternatively, the page cache 410 and/or controller 412 may be implemented on the same die as the memory 314. In one embodiment, the page cache 410 and/or controller 412 may be implemented on a different die than the cache 308 and/or the memory 314.

FIG. 5 illustrates a block diagram of an embodiment of a method 500 to transfer (or prefetch) data from a memory. In an embodiment, various components discussed with reference to FIGS. 1-4 and 6-7 may be utilized to perform one or more of the operations discussed with reference to FIG. 5. For example, the method 500 may be used to transfer (or prefetch) data into one or more caches of FIG. 4 through an interconnect (such as the vias 106).

Referring to FIGS. 1-5, at an operation 502, the cache controller 404 may receive a memory access request from one or more of the processor cores 306. At an operation 504, the cache controller 404 may determine whether data corresponding to the memory access request of the operation 502 is present in the cache 308 (e.g., including the caches 402). If the corresponding data is present in the cache 308, the cache controller 404 may return the data from the cache 308 at an operation 506.

In an embodiment, if the corresponding data of the operation 504 is absent from the cache 308, the page cache controller 412 may determine if the corresponding data is present in the page cache 410 at an operation 508. If the page cache 410 includes the corresponding data, the data may be copied from the page cache 410 into the cache 308 (e.g., including one or more of the caches 402) at an operation 510, for example, by the controllers 404 and/or 412.

In one embodiment, after the operation 504 determines that the data is absent from the cache 308, the cache controller 404 may generate a cache miss signal, and, in response to the cache miss signal, the logic 408 may generate one or more memory access (or prefetch) requests at an operation 512. The memory controller 406 may receive the memory access (or prefetch) requests through the vias 106 and/or interconnection 304 and open one or more corresponding pages (e.g., by activating one or more rows) in the memory 314 at an operation 514.

In an embodiment, at an operation 516, data may be copied from the memory 314 into a buffer such as the page cache 410, for example, by the controllers 404 and/or 412. At an operation 518, data may be copied through vias 106 from the page cache 410 and/or the memory 314 into the cache 308 (e.g., including one or more of the caches 402), for example, by the controllers 404, 406, and/or 412. After copying the data into the page cache 410 or the cache 308 (at operations 516 or 518, respectively), the opened memory pages of the operation 514 may be closed at an operation 520, for example, by the memory controller 406. As illustrated in FIG. 5, the method 500 continues with the operation 506 after the operations 510 and 520.

In an embodiment, upon occurrence of a cache miss (e.g., as determined at operation 504), one or more memory pages may be opened (514) to copy the corresponding data from the memory 314 into a buffer (such as the page cache 410 and/or cache 308) through the vias 106. The opened memory pages are then closed at operation 520, e.g., to conserve power, for example by turning off one or more corresponding sense amplifiers in the memory 314. In one embodiment, data copied through the vias 106 may include both data from a memory location in the memory 314 that corresponds to the memory access request of operation 502 as well as additional data, for example, from one or more neighboring or adjacent memory locations such as a preceding or a succeeding memory locations, rows, or pages. Accordingly, data copied through the vias 106 may include data from at least two contiguous memory locations, rows, or pages, in accordance with various embodiments of the invention.

In an embodiment, the memory access request of the operation 502 may correspond to a 64 byte block of data within the memory 314, and the techniques discussed herein may be utilized to instead copy a 1 kilo-byte block of data (e.g., including preceding or subsequent memory locations, or a full page) through the vias 106 into the cache 308 (or its various levels (402)), e.g., without closing the corresponding opened page(s) before the data transfer operations are completed. As discussed with reference to FIGS. 1-4, the memory 314 may be implemented on a separate die than the cache 308 and the vias 106 may provide a relatively high-speed communication mechanism for transferring or prefetching data from the memory 314 into the cache 308, e.g., without the delays associated with utilizing a shared interconnect or bus. In an embodiment, the cache 308, logic 408, and/or the cores 306 may be on the same die.

In one embodiment, a buffer such as the page cache 410 may be utilized to temporarily store the transferred (or prefetched) data from the memory 314 before the data is drained or copied into the cache 308 (or its various levels), e.g., for access by the cores 306. In an embodiment, the page cache 410 may include less expensive data storage elements than those utilized for the memory 314. Furthermore, more open pages may be maintained in the page cache 410 (e.g., to improve performance) than the memory 314, for example, due to less power consumption by the data storage elements of the page cache 410 than the memory 314.

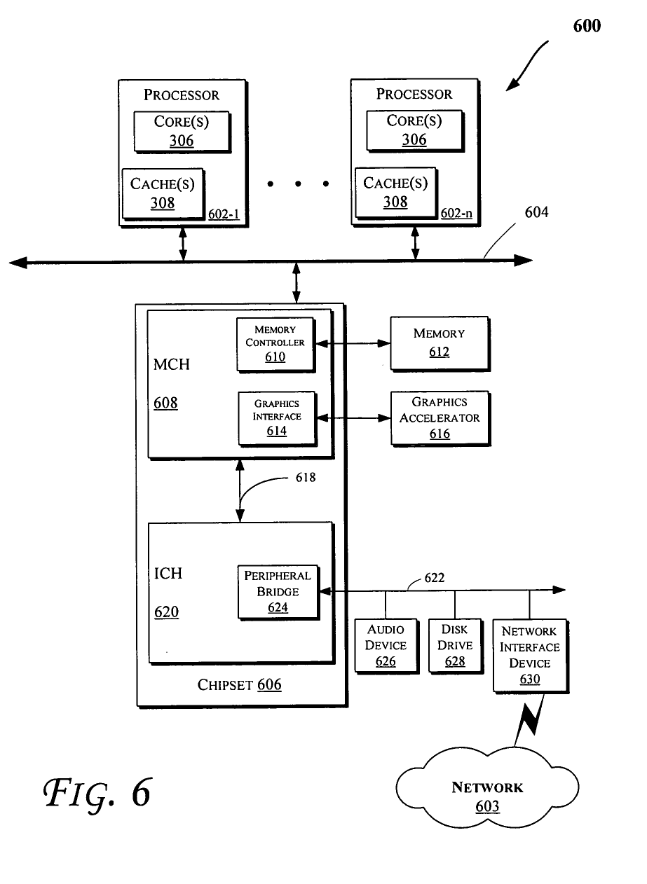

FIG. 6 illustrates a block diagram of a computing system 600 in accordance with an embodiment of the invention. The computing system 600 may include one or more central processing unit(s) (CPUs) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an embodiment, one or more of the processors 602 may be the same or similar to the processors 302 of FIG. 3. For example, one or more of the processors 602 may include one or more of the cores 306 and/or cache 308. Also, the operations discussed with reference to FIGS. 1-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612 (which may be the same or similar to the memory controller 406 of FIG. 4 and the memory 314 of FIGS. 3 and 4, respectively). In an embodiment, vias 106 may be utilized to transfer (or transmit) data between the caches 308 and the memory 612. The memory 612 may store data, including sequences of instructions that are executed by the CPU 602, or any other device included in the computing system 600. In one embodiment of the invention, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple CPUs and/or multiple system memories.

The MCH 608 may also include a graphics interface 614 that communicates with a graphics accelerator 616. In one embodiment of the invention, the graphics interface 614 may communicate with the graphics accelerator 616 via an accelerated graphics port (AGP). In an embodiment of the invention, a display (such as a flat panel display) may communicate with the graphics interface 614 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 618 may allow the MCH 608 and an input/output control hub (ICH) 620 to communicate. The ICH 620 may provide an interface to I/O devices that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the CPU 602 and peripheral devices. Other types of topologies may be utilized. Also, multiple buses may communicate with the ICH 620, e.g., through multiple bridges or controllers. Moreover, other peripherals in communication with the ICH 620 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some embodiments of the invention. In addition, the processor 602 and the MCH 608 may be combined to form a single chip. Furthermore, the graphics accelerator 616 may be included within the MCH 608 in other embodiments of the invention.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

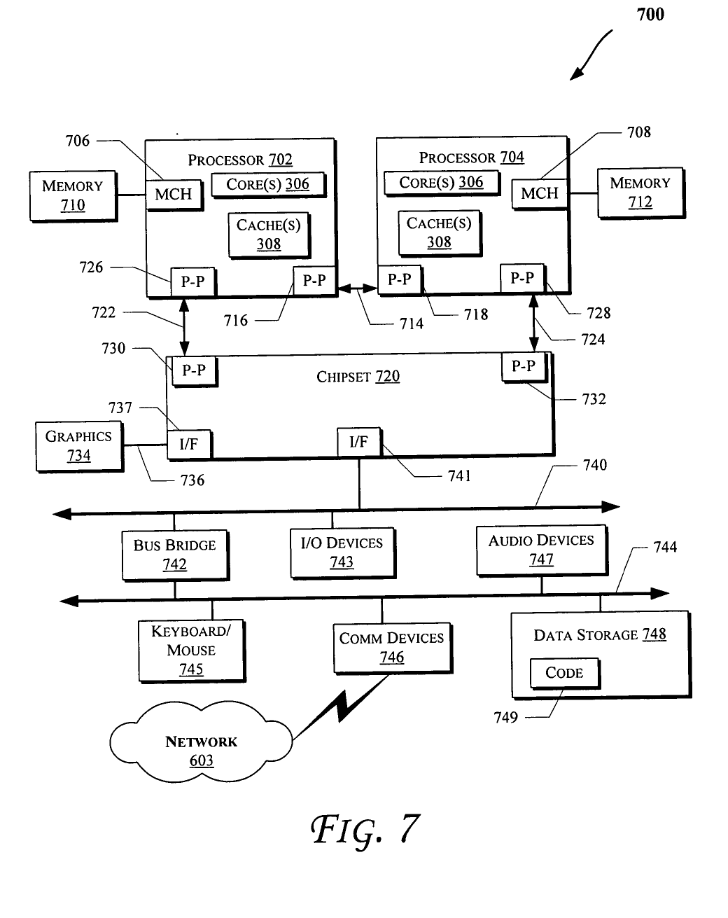

FIG. 7 illustrates a computing system 700 that is arranged in a point-to-point (PtP) configuration, according to an embodiment of the invention. In particular, FIG. 7 shows a system where processors, memory, and input/output devices are interconnected by a number of point-to-point interfaces. The operations discussed with reference to FIGS. 1-6 may be performed by one or more components of the system 700.

As illustrated in FIG. 7, the system 700 may include several processors, of which only two, processors 702 and 704 are shown for clarity. The processors 702 and 704 may each include a local memory controller hub (MCH) 706 and 708 to enable communication with memories 710 and 712. The memories 710 and/or 712 may be the same as or similar to the memory 612 of FIG. 6. In an embodiment, vias 106 may be utilized to transfer data between the caches 308 and the memories 710 and 712.

In an embodiment, the processors 702 and 704 may be one of the processors 602 discussed with reference to FIG. 6. The processors 702 and 704 may exchange data via a point-to-point (PtP) interface 714 using PtP interface circuits 716 and 718, respectively. Also, the processors 702 and 704 may each exchange data with a chipset 720 via individual PtP interfaces 722 and 724 using point-to-point interface circuits 726, 728, 730, and 732. The chipset 720 may further exchange data with a high-performance graphics circuit 734 via a high-performance graphics interface 736, e.g., using a PtP interface circuit 737.

At least one embodiment of the invention may be provided within the processors 702 and 704. For example, one or more of the cores 306 and/or cache 308 of FIG. 3 may be located within the processors 702 and 704. Other embodiments of the invention, however, may exist in other circuits, logic units, or devices within the system 700 of FIG. 7. Furthermore, other embodiments of the invention may be distributed throughout several circuits, logic units, or devices illustrated in FIG. 7.

The chipset 720 may communicate with a bus 740 using a PtP interface circuit 741. The bus 740 may have one or more devices that communicate with it, such as a bus bridge 742 and I/O devices 743. Via a bus 744, the bus bridge 743 may communicate with other devices such as a keyboard/mouse 745, communication devices 746 (such as modems, network interface devices, or other communication devices that may communicate with the computer network 603), audio I/O device, and/or a data storage device 748. The data storage device 748 may store code 749 that may be executed by the processors 702 and/or 704.

In various embodiments of the invention, the operations discussed herein, e.g., with reference to FIGS. 1-7, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 1-7.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
logic to generate a first memory access request in response to a cache miss corresponding to a first cache line; and
an interconnect to transfer a first open page of a memory that comprises data corresponding to the first cache line into a buffer before the first page of the memory is closed.

2. The apparatus of claim 1, further comprising a memory controller to open the first page of the memory and close the first opened memory page after all data stored in the first opened memory page is copied to the buffer through the interconnect.

3. The apparatus of claim 2, wherein the memory controller keeps the first page of the memory open during execution of one or more operations corresponding to the first memory access request.

4. The apparatus of claim 1, wherein the interconnect comprises a plurality of vias.

5. The apparatus of claim 1, wherein the first page of the memory comprises data corresponding to at least a second cache line.

6. The apparatus of claim 1, further comprising a cache controller to generate a cache miss signal after the cache miss occurs, wherein the logic generates the first memory access request in response to the cache miss signal.

7. The apparatus of claim 1, wherein the logic generates a second memory access request in response to the cache miss, the second memory access request to cause opening of a second page of the memory.

8. The apparatus of claim 7, wherein the second page of the memory is contiguous with the first page of the memory.

9. The apparatus of claim 7, further comprising a cache controller to generate a cache miss signal after the cache miss occurs, wherein the logic generates the second memory access request in response to the cache miss signal.

10. The apparatus of claim 1, further comprising a first die that comprises the logic and a second die that comprises the memory.

11. The apparatus of claim 1, wherein the buffer comprises a shared or a private cache.

12. The apparatus of claim 1, wherein the buffer comprises a page cache to store the data stored in the first opened memory page prior to copying the data to a cache.

13. The apparatus of claim 1, further comprising one or more processor cores to generate a memory access request that causes the cache miss.

14. The apparatus of claim 13, wherein the one or more processor cores and the logic are on a first die.

15. The apparatus of claim 14, wherein the first die comprises a bulk Si layer, an active Si layer, and a metal stack layer.

16. The apparatus of claim 15, further comprising a heat sink coupled to the bulk Si layer to dissipate heat.

17. The apparatus of claim 14, further comprising a second die that comprises the memory, wherein a plurality of vias couple at least a portion of the first die and at least a portion of the second die.

18. The apparatus of claim 17, wherein the second die comprises a bulk Si layer, an active Si layer, and a metal stack layer.

19. The apparatus of claim 17, wherein the first die and the second die are stacked on each other.

20. The apparatus of claim 17, further comprising one or more through-die vias to couple one or more bumps to one or more of the plurality of vias.

21. A method comprising:
generating one or more memory access requests in response to a cache miss;
opening one or more memory pages corresponding to the one or more memory access requests; and
copying data stored in the one or more opened memory pages to a buffer through a non-shared interconnect.

22. The method of claim 21, further comprising closing the one or more opened memory pages after data stored in the one or more opened memory pages are entirely copied to the buffer.

23. The method of claim 21, wherein opening the one or more memory pages comprises activating one or more rows of a memory.

24. The method of claim 21, wherein copying the data stored in the one or more opened memory pages to the buffer comprises copying the data from a memory to a page cache.

25. The method of claim 24, further comprising copying the data from the page cache to one or more of a shared cache or a private cache.

26. A system comprising:
a memory to store data;
a cache to store data corresponding to at least some of the data stored in the memory;
a first logic to generate a first request for data stored in a first location of the memory and a second request for data stored in a second location of the memory in response to a request for the data stored in the first location; and
a second logic to copy the data stored in the first and second locations into the cache and turn off one or more data storage elements coupled to the first and second locations of the memory after the data stored in the first and second locations is copied into the cache through a non-shared interconnect.

27. The system of claim 26, further comprising one or more processor cores to send the request for data stored in the first location.

28. The system of claim 26, wherein the first location and the second location of the memory are contiguous.

29. The system of claim 26, further comprising a first die that is stacked on a second die, wherein the first die comprises the cache and the first logic and wherein the second die comprises the memory.

30. The system of claim 26, further comprising an audio device.
